(19) United States
(12) Patent Application Publication
(10) Pub. No.: US 2006/0007383 A1
(43) Pub. Date: Jan. 12, 2006

(54) Liquid crystal display panel with perforated transmission lines

(76) Inventors: Yun Szu Liu, Miao-Li (TW); Kun Hsing Hsiao, Miao-Li (TW); Yu-Cheng Chang, Miao-Li (TW); Tsau-Hua Hsieh, Miao-Li (TW); Jia-Pang Pang, Miao-Li (TW)

Correspondence Address: WEI TE CHUNG;FOXCONN INTERNATIONAL, INC., 1650 MEMOREX DRIVE, SANTA CLARA, CA, 95050, US

(21) Appl. No.: 11/169,397

(22) Filed: Jun. 28, 2005

(30) Foreign Application Priority Data
Jun. 28, 2004 (CN) 200410027936X

(51) Int. Cl. G02F 1/1339

(52) U.S. Cl. 349/153

(57) ABSTRACT

A LCD panel (200) includes a first substrate (201) and a second substrate (202) opposite to each other, a liquid crystal layer interposed between the first and second substrates, a sealant (216) disposed between the first and second substrates and surrounding the liquid crystal layer, a plurality of gate lines (208) and data lines (209) perpendicularly formed on the first substrate. Each gate line and each data line define a plurality of overlapping areas overlapped by the sealant. Each overlapping area has at least an opening. In the LCD panel, each gate lines and each data lines have a plurality of openings on the overlapping areas. Thus, ultraviolet light would completely cure the sealant. That is the LCD panel has a high quality display effect.

### FIELD OF THE INVENTION

The present invention relates to a liquid crystal display (LCD) panel, and especially to an LCD panel manufactured by a one-drop-fill (ODF) method.

### BACKGROUND

An LCD panel generally includes two glass substrates, a peripheral sealant, and a plurality of liquid crystal molecules disposed between the substrates. The sealant is printed on one of the glass substrates, and then adhered to the other glass substrate. The substrates and the sealant cooperatively form a space therebetween, with the liquid crystal molecules being filled in the space.

There are generally two methods used for filling the liquid crystal molecules into the space. The first method is to fill the liquid crystal molecules through filling ports. This method includes the following steps: firstly, coating a sealant on a first glass substrate, the sealant being rectangular and having one or more gaps that function as filling ports; secondly, attaching a second glass substrate to the first glass substrate and curing the sealant, with a space being enclosed by the sealant and the two glass substrates; thirdly, immersing the filling ports in a liquid crystal in a vacuum chamber; and finally, introducing gas into the vacuum chamber to make the liquid crystal molecules fill up the space.

The second method is the so-called one-drop-fill (ODF) method. This method comprises the following steps: firstly, printing a sealant on a first glass substrate, wherein the sealant is rectangular and continuous, and a space is enclosed by the sealant and the first glass substrate; secondly, putting liquid crystal molecules into the space drop by drop using a dispenser; and finally, combining a second glass substrate with the first glass substrate and curing the sealant.

Referring to FIG. 8, a conventional LCD panel 100 includes a first substrate 101 and a second substrate 102 disposed opposite to each other and spaced apart a predetermined distance, and a liquid crystal layer (not shown) containing a plurality of liquid crystal molecules disposed between the first and second substrates 101 and 102.

A sealant 116 surrounds the liquid crystal layer. The sealant 116 is arranged between the first and second substrates 101 and 102, and supports the first and second substrates 101 and 102 so that the space therebetween is maintained. A plurality of gate lines 108 and data lines 109 are cross-formed on the first substrate 101, thereby defining a plurality of pixel regions. Each of the pixel regions includes a thin film transistor (TFT), the TFT functioning as a driver element. First and second conductive pads 114 and 115 are arranged on the first substrate 101 outside of the sealant 116. Ends of the gate lines 108 and data lines 109 are respectively electrically connected to the first and second conductive pads 114 and 115. The first conductive pads 114 are electrically connected to a gate driver IC (not shown), and convey scanning signals to the gate lines 108. The second conductive pads 115 are electrically connected to a data driver IC (not shown), and convey data signals to the data lines 109.

A color filter (not shown) and a black matrix 103 are arranged on the second substrate 102. The black matrix 103 is made of opaque metal, such as Cr. The black matrix 103 shelters the gate lines 108, data lines 109, sealant 116 and TFT from irradiation by an external light source.

The LCD panel 100 is manufactured by the one-drop-fill (ODF) method, with the sealant 116 being made of an ultraviolet curing adhesive. An ultraviolet light source is provided outside of the first substrate 101, in order to cure the sealant 116.

Referring to FIG. 9, on the LCD panel 100, the sealant 116 partly covers the gate line 108 and the data line 109. Since the gate line 108 and the data line 109 are made of opaque metal, when the ultraviolet light source cures the sealant 116, some of the ultraviolet light is blocked by the gate line 108 and the data line 109. Accordingly, portions of the sealant 116 covered by the gate line 108 and the data line 109 may not be completely cured. This may reduce the strength and reliability of the LCD panel 100. In addition, the sealant 116 is liable to mix with and contaminate adjacent liquid crystal molecules. Both these problems can adversely affect the display image generated by the liquid crystal layer.

What is needed, therefore, is an LCD panel with a high quality, reliable display effect.

### SUMMARY

In an exemplary embodiment of the present invention, an LCD panel includes a first substrate and a second substrate opposite to each other, a liquid crystal layer interposeed between the first and second substrates, a sealant disposed between the first and second substrates and surrounding the liquid crystal layer, a plurality of gate lines and data lines perpendicularly formed on the first substrate. Each gate line and each data line define a plurality of overlapping areas overlapped by the sealant. Each overlapping area has at least an opening.

Each gate lines and data lines would include a discontinuous region, the discontinuous region has at least an opening.

In the LCD panel, each gate lines and data lines have a plurality of openings on the overlapping areas. Thus, ultraviolet light irradiate the sealant on the overlapping areas through the openings, and would completely cure the sealant, the sealant is not liable to pollute the liquid crystal molecules. That is, the LCD panel has a high quality display effect.

Other novel features and advantages will become more apparent from the following detailed description when taken in conjunction with the accompanying drawings.

### BRIEF DESCRIPTION OF THE DRAWINGS

FIG. 1 is an abbreviated, cut-away top plan view of part of an LCD panel according to a first embodiment of the present invention.

FIG. 2 is an enlarged, isometric view of part of the LCD panel shown in FIG. 1, showing a sealant overlying a plurality of gate lines on a substrate.

FIG. 3-FIG. 5 are various simplified views of sequential stages in a process for forming openings in the gate lines of the LCD panel in accordance with the first embodiment.

FIG. 6 is an enlarged, top cross-sectional view of a pattern of openings in a gate line of an LCD panel according to a second embodiment of the present invention.

FIG. 7 is an enlarged, top cross-sectional view of a pattern of openings in a gate line of an LCD panel according to a third embodiment of the present invention.

FIG. 8 is an abbreviated, cut-away top plan view of part of a conventional LCD panel.

FIG. 9 is an enlarged, isometric view of part of the LCD panel shown in FIG. 8, showing a sealant overlying a plurality of gate lines on a substrate.

### DETAILED DESCRIPTION OF PREFERRED EMBODIMENTS

Referring to FIG. 1, an LCD panel 200 according to a first embodiment of the present invention includes a first substrate 201 and a second substrate 202 disposed opposite to each other and spaced apart a predetermined distance, and a liquid crystal layer (not shown) containing a plurality of liquid crystal molecules is disposed between the first and second substrates 201 and 202.

A sealant 216 is disposed between the first and second substrates 201 and 202, such that the sealant 216 surrounds the liquid crystal layer. A plurality of gate lines 208 and data lines 209 are crosswisedly formed on the first substrate 201, thereby defining a plurality of pixel regions. Each of the pixel regions includes a thin film transistor (TFT), the TFT functioning as a driver element. A plurality of first and second conductive pads 214 and 215 are arranged on the first substrate 201 outside of the sealant 216. Ends of the gate lines 208 and the data lines 209 are respectively electrically connected to the first and second conductive pads 214 and 215. The first conductive pads 214 are electrically connected to a gate driver IC (not shown), and convey scanning signals to the gate lines 208. The second conductive pads 215 are electrically connected to data driver IC (not shown), and convey data signals to the data lines 209.

A color filter (not shown) and a black matrix 203 are arranged on the second substrate 202. The black matrix 203 is made of opaque metal, such as Cr, and shelters the gate lines 208, data lines 209, sealant 216 and TFTs from irradiation by ambient light. The sealant 216 is a rectangular, continuous body made of an ultraviolet curing adhesive. An ultraviolet light source outside of the first substrate 201 is used to cure the sealant 216.

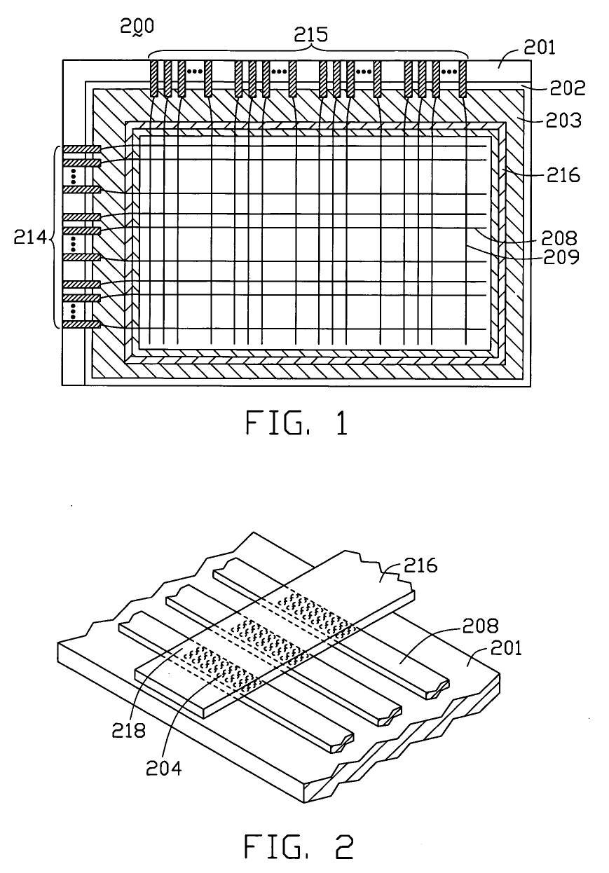

Also referring to FIG. 2, this is an enlarged view of the sealant 216 overlying a plurality of the gate lines 208. Each gate line 208 is partially overlapped by the sealant 216, thereby defining a plurality of overlapping areas 218 of the gate line 208. Each overlapping area 218 has a plurality of openings 204. Each opening 204 is circular. A diameter of the opening 204 is in the range from 1 to 5 microns, and a distance separating each two adjacent openings 204 is in the range from 1 to 5 microns. In this exemplary embodiment of the present invention, the diameter of each opening 204 is 3 microns. Each data line 209 is also partially overlapped by the sealant 216, thereby defining a further plurality of overlapping areas 218 of the data line 209.

When an ultraviolet light source is used at the outside of the first substrate 201 to cure the sealant 216, some of the ultraviolet light directly irradiates parts of the sealant 216 behind the overlapping areas 218 via the openings 204. On the other hand, a total area of the openings 204 in each overlapping area 216 is less than 90% of the total area of the overlapping area 216. This configuration helps ensure that the sealant 216 behind the overlapping areas 218 can be effectively cured, while also helping to ensure that scanning and data signals can be effectively transmitted through the gate and data lines 208, 209.

In summary of the LCD panel 200, each of the gate lines 208 and data lines 209 has a plurality of openings 204 in the overlapping areas 218 thereof. Ultraviolet light irradiates the sealant 216 behind the overlapping areas 218 through the openings 204, and thus can completely cure the sealant 216 thereat. As a result, the sealant 216 is prevented from contaminating the liquid crystal molecules. That is, the LCD panel 200 can provide a high quality display effect.

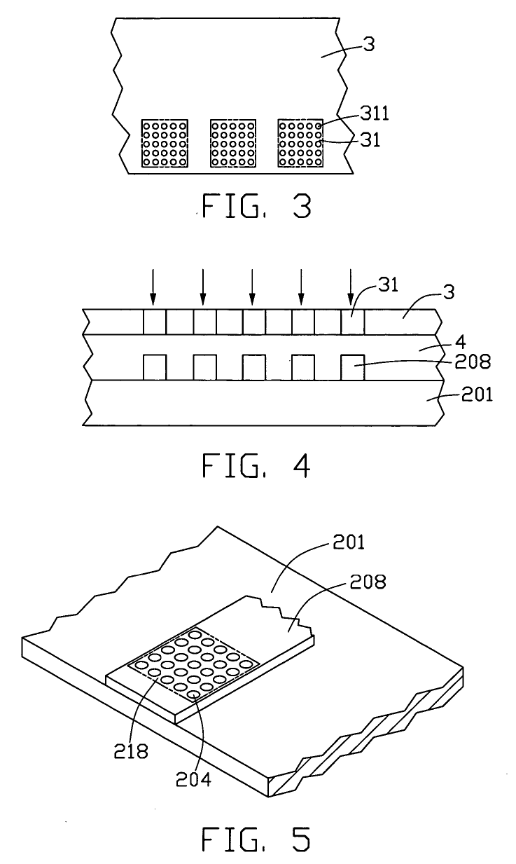

The openings 204 are formed by a photo mask and etching process. Referring to FIG. 3, this shows a schematic, abbreviated top view of a photo mask 3. The photo mask 3 includes an opening pattern 31. The opening pattern 31 includes a plurality of circular openings 311. The opening pattern 31 is located corresponding to one of the overlapping areas 218 of the LCD panel 200.

Referring to FIG. 4 and FIG. 5, the gate lines 208 are formed on the first substrate 201. A photo resist layer 4 is uniformly coated on the gate lines 208 and the first substrate 201. The photo mask 3 is positioned above the photo resist layer 4. Light beams irradiate the photo resist layer 4 through the openings 311, and form a photo resist pattern on the gate lines 208. Then the gate lines 208 are etched, thereby forming the openings 208 on an area of the gate lines 208 corresponding to openings 311. A corresponding procedure is performed for the data lines 209.

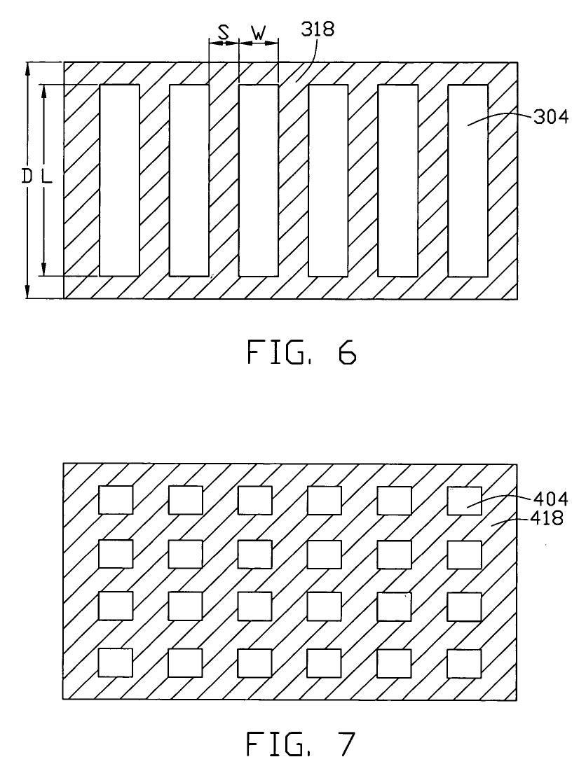

Referring to FIG. 6, this shows a schematic, top view of a second embodiment of the opening pattern of the gate lines 208. The opening pattern includes a plurality of rectangular openings 304. The openings 304 are parallel to each other. A length L of the openings 304 is less than a breadth D of the date lines 208. A distance S separating each two adjacent openings 304 is less than a breadth W of the openings 304. In the illustrated embodiment, the distance S is less than 50 microns. A total area of the openings 304 in each overlapping area 318 is less than 90% of a total area of the overlapping area 318. In this embodiment, the length L of the openings 304 is equal to the breadth D of the date lines 208.

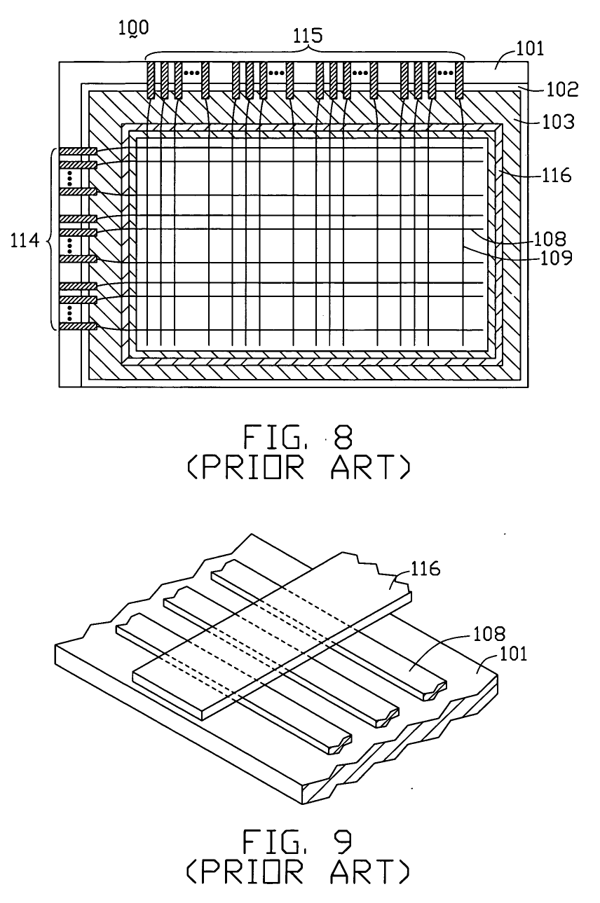

Referring to FIG. 7, this shows a schematic, top view of a third embodiment of the opening pattern of the gate line 208. The opening pattern includes a plurality of square openings 404, the openings 404 cooperatively forming matrix array. A total area of the openings 404 in each overlapping area 418 is less than 90% of a total area of the overlapping area 418.

In the LCD panel, the openings of the data lines have the same configuration as the openings of the gate lines. The openings of the gate lines and the data lines can alternatively be elliptical, triangular, or polygonal. The sealant can alternatively be made of a mixture of an ultraviolet curing adhesive and a heat curing adhesive.

In the LCD panel, each gate lines and data lines have a plurality of openings on the overlapping areas, ultraviolet light irradiate the sealant on the overlapping areas through the openings, and would completely cure the sealant, the sealant is not liable to pollute the liquid crystal molecules. That is, the LCD panel has a high quality display effect.

It is to be understood, however, that even though numerous characteristics and advantages of the present invention have been set forth in the foregoing description, together with details of the structure and function of the invention, the disclosure is illustrative only, and changes may be made in detail to the full extent indicated by the broad general meaning of the terms in which the appended claims are expressed.

What is claimed is:

1. A liquid crystal display panel, comprising:
a first substrate and a second substrate opposite to each other;
a liquid crystal layer interposed between the first and second substrates;
a sealant disposed between the first and second substrates and surrounding the liquid crystal layer; and
a plurality of gate lines and data lines perpendicularly formed on the first substrate; each gate line and each data line defining a plurality of overlapping areas overlapped by the sealant;
wherein each overlapping area has at least an opening.

2. The liquid crystal display panel as claimed in claim 1, wherein the gate lines and the data lines are made of opaque metal.

3. The liquid crystal display panel as claimed in claim 1, wherein a shape of the opening is circular.

4. The liquid crystal display panel as claimed in claim 3, wherein a diameter of the opening is in the range of 1 to 5 microns.

5. The liquid crystal display panel as claimed in claim 4, wherein a distance separating each two adjacent openings is in the range of 1 to 5 microns.

6. The liquid crystal display panel as claimed in claim 5, wherein the occupation of an area of the openings in each overlapping area is less than 90%.

7. The liquid crystal display panel as claimed in claim 1, wherein a shape of the opening is rectangular.

8. The liquid crystal display panel as claimed in claim 7, wherein a length of the opening is less than a width of the gate line or data line.

9. The liquid crystal display panel as claimed in claim 8, wherein a distance separating each two adjacent openings is less than 50 microns.

10. The liquid crystal display panel as claimed in claim 9, wherein a width of the opening is larger than the distance separating each two adjacent openings.

11. The liquid crystal display panel as claimed in claim 10, wherein the occupation of an area of the openings in each overlapping portion is less than 90%.

12. The liquid crystal display panel as claimed in claim 1, wherein a shape of the opening is polygonal.

13. The liquid crystal display panel as claimed in claim 12, wherein the shape of the opening is square.

14. The liquid crystal display panel of claim 1, wherein the sealant is a rectangular and continuous body.

15. A liquid crystal display panel, comprising:
a first substrate and a second substrate opposite to each other;
a liquid crystal layer interposed between the first and second substrates;
a sealant disposed between the first and second substrates and surrounding the liquid crystal layer; and
a plurality of gate lines and data lines perpendicularly formed on the first substrate, each gate line and each data line comprising a discontinuous region, the discontinuous region having at least an opening.

16. The liquid crystal display panel as claimed in claim 17, wherein the gate lines and the data lines are made of opaque metal.

17. The liquid crystal display panel as claimed in claim 17, wherein the discontinuous region is overlapped by the sealant.

18. The liquid crystal display panel as claimed in claim 17, wherein a shape of the opening is circular, rectangular, square, or polygonal.

19. A method of solidifying sealant between first and second substrate, comprising:
providing a first substrate and a second substrate opposite to each other wherein each of said first substrate and said second substrate defining opposite interior and exterior faces;
disposing a liquid crystal layer interposed between the interior faces of the first and second substrates;
providing a sealant disposed between the interior faces of the first and second substrates and surrounding the liquid crystal layer; and
providing a plurality of gate lines and data lines perpendicularly formed on the first substrate; said gate lines and said data lines defining a plurality of overlapping regions overlapped by the sealant;
wherein each overlapping region defines at least one recessed area so as to allow light irradiate the sealant around the overlapping region via said recessed area when said light comes from the exterior face of the first substrate.
